(19) United States
(12) Patent Application Publication
(10) Pub. No.: US 2011/0154240 A1
(43) Pub. Date: Jun. 23, 2011

(54) Measurement Data Analysis Processing Apparatus and Program Therefor

(75) Inventors: Satoshi YAMAMOTO, Otsu-shi (JP); Atsushi MATSUDAIRA, Suita-shi (JP)

(73) Assignee: SHIMADZU CORPORATION, Kyoto-shi (JP)

(21) Appl. No.: 12/874,953

(22) Filed: Sep. 2, 2010

(30) Foreign Application Priority Data
Dec. 17, 2009 (JP) 2009-286573

(51) Int. Cl. G06F 3/048

(52) U.S. Cl. 715/771

(57) ABSTRACT

Work required for the creation of reports based on measurement data obtained by a specimen measurement apparatus was reduced. A data analysis processing apparatus for creating reports by supplying measurement data to a report template includes: a display screen 50; a graph/table creation means 22 for allowing a user to create graphs/tables based on measurement data; a screen image creation means 23 for displaying the graph/table that was created by the graph/table creation means 22 on a display screen 50, allowing the user to defines the form, size and layout of each of the graphs/tables that are displayed, and creating a screen image; an output media setting means 60 for defining the size and shape of the output media; and a report automatic template creation means 241 for using the screen image that was created by the screen image creation means 23 to create a template that fits the size and shape of the output media that is defined by the output media setting means 60. The screen image that is defined by the user is used as a basis to automatically create a template that fits the shape and size of the output media, thus reducing the work required for the creation of reports.

### TECHNICAL FIELD

The present invention relates to a data analysis processing apparatus that analyzes and processes measurement data on a specimen that is acquired by a specimen measurement apparatus, and also relates to a data analysis processing program used therefor.

### BACKGROUND

Currently, most specimen measurement apparatuses are computer controlled, and a dedicated software for the particular measurement apparatus is used to control the measurement of a specimen and to analyze and process the measured data.

The measurement data of a particular specimen obtained by a specimen measurement apparatus are often represented as graphs or tables and are output as reports for the analysis of the measurement results. This means that many of the dedicated software for measurement apparatuses also have a built-in report creation function.

A report creation function is a function that allows graphs, tables and other items that are meant to be shown together in a single report to be displayed on the same screen at the same time so that a user can freely define the display format, size, shape, layout and the like to fit the size and shape of the report form or the report screen.

In the case where a measurement data acquired by a measurement apparatus is used as the basis for creating a plurality of reports having the same format, the cumbersome work of the user having to define the format for each report can be eliminated if a report template that defines the format of the reports can be used. Here, the term “report template” refers to a form that defines for a report form or a report screen of a particular size and shape such things as the size, shape and display format of graphs, tables and other items (hereinafter referred to as “report objects”) to be displayed and the layout relationship between the report objects. By creating one report template, a plurality of reports can be created simply by supplying a plurality of sets of measurement data to the report template. For the convenience of the user, a report creation function often includes a collection of templates prepared by the measurement apparatus manufacturer.

However, because there is no guarantee that an existing template collection will include a template that matches the user's needs, a report creation function oftentimes includes a template creation function. Previously, a user will use a template creation function to create a desired report template (Patent Literature 1).

### PRIOR LITERATURE

### Patent Literature

Patent Literature 1: Unexamined Patent Application Publication 2004-94386

### SUMMARY OF THE INVENTION

### Problems to be Solved by the Invention

The work involved in the creation of a report template is described. The user uses the screen to define the layout, size and shape of the report objects to be displayed which are appropriate for the shape and size of the desired report form or the report screen. When doing this, careful attention must be paid to the positions and distances separating the respective report objects. The creation of one report template can be laborious. Furthermore, if the size and shape of the report output paper have to be changed while using the same image, or if space has to be provided for displaying a new display item, a new report template appropriate for that has to be newly created. This work can be very burdensome on the user.

The present invention has been made in light of the afore-described problems, and it is the object of the present invention to reduce the work involved in the creation of a report based on measurement data that is acquired by a specimen measurement apparatus.

### Means for Solving the Problems

A first mode of the present invention that has been made to solve the afore-described problems is a data analysis processing apparatus wherein reports are created simply by supplying measurement data to a report template, the data analysis processing apparatus including: a display screen, a graph/table creation means for allowing a user to create graphs/tables based on measurement data, a screen image creation means for displaying on the display screen one or more graphs/tables that were created by the graph/table creation means and allowing a user to define the form, size and layout of each of the graphs/tables that are displayed and thereby creating a screen image, an output media setting means for defining the size and shape of the output media to which displayed objects on the display screen are output, and an automatic report template file creation means for using the screen image that was created by the screen image creation means to create a report template file that matches the size and shape of the output media that is defined by the output media setting means.

A second mode of the present invention that has been made to solve the afore-described problems is a specimen measurement apparatus including: a specimen measurement unit that measures a specimen, and a data analysis processor that creates a report by supplying measurement data obtained by the specimen measurement unit to a report template, wherein the data analysis processor comprises: a display screen, a graph/table creation means for allowing a user to create graphs/tables based on measurement data, a screen image creation means for displaying on the display screen one or more graphs/tables that were created by the graph/table creation means and allowing a user to define the form, size and layout of each of the graphs/tables that are displayed and thereby creating a screen image, an output media setting means for defining the size and shape of the output media to which displayed objects on the display screen are output, and an automatic report template file creation means for using the screen image that was created by the screen image creation means to create a report template file that matches the size and shape of the output media that is defined by the output media setting means.

A third mode of the present invention that has been made to solve the afore-described problems is a program which is for execution on a computer including a display screen; an output means for outputting displayed objects that are displayed on said display screen to an output media; and a function for creating a report by supplying measurement data to a report template. The program comprises a graph/table creation function for allowing a user to create graphs/tables based on measurement data, a screen image creation function for displaying on the display screen one or more graphs/tables that are created by the graph/table creation function and allowing a user to define the form, size and layout of each of the graphs/tables that are displayed and thereby creating a screen image, and an automatic report template file creation function for using the screen image that was created by said screen image creation means to create a report template file that matches the size and shape of the output media.

### Effects of the Invention

With a data analysis processing apparatus, specimen measurement apparatus and a data analysis program according to the present invention, a report template that is adapted to the shape and size of the report output media (report form or report screen) is automatically created based on a screen image that is defined in advance by a user. Accordingly, the user himself does not have to create a report template and instead only needs to create a screen image. This completely eliminates the work required during the creation of a report template of trying to fit the shape and size of the output media. Also, similar screen images can be used to very easily create multiple report templates whose output media has different shapes and sizes.

Ordinarily, when the measurement of a specimen is completed, before the creation of a report, the user lays out on the same screen the graphs and tables that were created from the measured data to compare and study the graphs and tables. According to the present invention, the screen image that is defined for this type of comparison and study is used as the basis for the automatic creation of a template. If this is done, the need to create a screen image solely to serve as a basis for the automatic creation of a report template is eliminated, further reducing the labor required for the creation of a report template.

### BRIEF DESCRIPTION OF THE FIGURES

FIG. 1 is a block diagram showing the general configuration of an embodiment of an analysis processing apparatus.

FIG. 2 shows one example of a display screen image in the present embodiment of an analysis processing apparatus.

FIG. 3 shows a template that was automatically created based on the screen image shown in FIG. 2 by the present embodiment of the analysis processing apparatus.

FIG. 4 shows a report that was created based on the template shown in FIG. 3 by the present embodiment of the analysis processing apparatus.

FIG. 5 shows one example of a display style change screen for report objects in a variation of the present embodiment of the analysis processing apparatus.

FIG. 6 shows one example of a report that was created by a variation of the present embodiment of the analysis processing apparatus.

### MODES FOR PRACTICING THE INVENTION

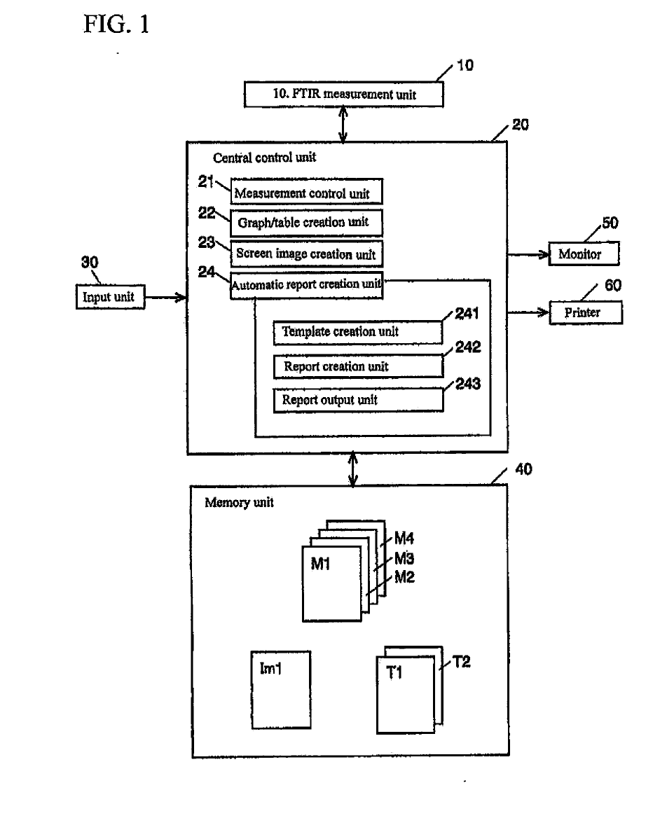

Embodiments of the present invention are described next with reference to FIGS. 1 through 6.

### Embodiments

FIG. 1 is a block diagram showing the general configuration of one embodiment of the present invention used with a Fourier transform infrared spectroscopy (FTIR) apparatus.

The FTIR apparatus according to the present embodiment includes a FTIR measurement unit 10, central control unit 20, input unit 30 through which user instructions are input, memory unit 40 that stores data and the like, monitor 50 and a printer 60.

With the FTIR apparatus according to the present embodiment, a dedicated software for the FTIR apparatus is stored in memory unit 40. When the dedicated software is initiated by a user instruction entered from the input unit 30, the central control unit 20 functions as measurement control unit 21, graph/table creation unit 22, screen image creation unit 23 and automatic report creation unit 24.

The FTIR measurement unit 10 performs FTIR measurement on the specimen under the control of the measurement control unit 21. The graph/table creation unit 22 creates graphs, tables and the like based on measurement data obtained by the FTIR measurement unit 10. The screen image creation unit 23 follows user instructions entered from the input unit 30 and defines the display style, size, aspect ratio and the like for graphs, tables and the like that are created by the graph/table creation unit 22. The screen image creation unit 23 appropriately lays out the graphs, tables and the like on monitor 50 and creates a screen image.

The automatic report creation unit 24 creates a template and supplies data to the template and automatically creates a report. The automatic report creation unit 24 includes a template creation unit 241, report creation unit 242 and report output unit 243.

The template creation unit 241 automatically creates a report template based on the size and shape of a report form that is defined in advance while reflecting the screen image that is created by the screen image creation unit 23. The report creation unit 242 creates a report by supplying data to the report template that is automatically created by the template creation unit 241. Specifically, when the user selects the data to be included in a report that is to be created from the measurement data acquired by the FTIR measurement unit 10 and stored in the memory unit 40, the data is supplied to the report template, and a plurality of reports sharing the same template is automatically created. The reports that are created are printed by the report output unit 243 from printer 60.

The procedure by which an analysis processing apparatus according to the present embodiment performs an FTIR analysis on four specimens S1 through S4, automatically creates a report regarding the analysis measurement data and prints out the report from a printer is described next.

When user instructions are entered from the input unit 30, the FTIR measurement unit 10 performs FTIR measurement on specimens S1 through S4 in accordance with the control that is implemented by the measurement control unit 21. The measurement data that is obtained by the FTIR measurement is stored in memory unit 40 as measurement data files M1 through M4.

Next, when the user selects a measurement data file that is to be displayed in a report from the measurement data files that are stored in the memory unit 40, the graph/table creation unit 22 creates graphs, tables and the like based on the selected data file. With the present embodiment, measurement data M1 through M4 are selected, and the graph/table creation unit 22 creates a table (Table 4) concerning the absorption spectrum (Graphs 1 through 4) for M1 through M4 and the peak intensity of the absorption spectrum for M4.

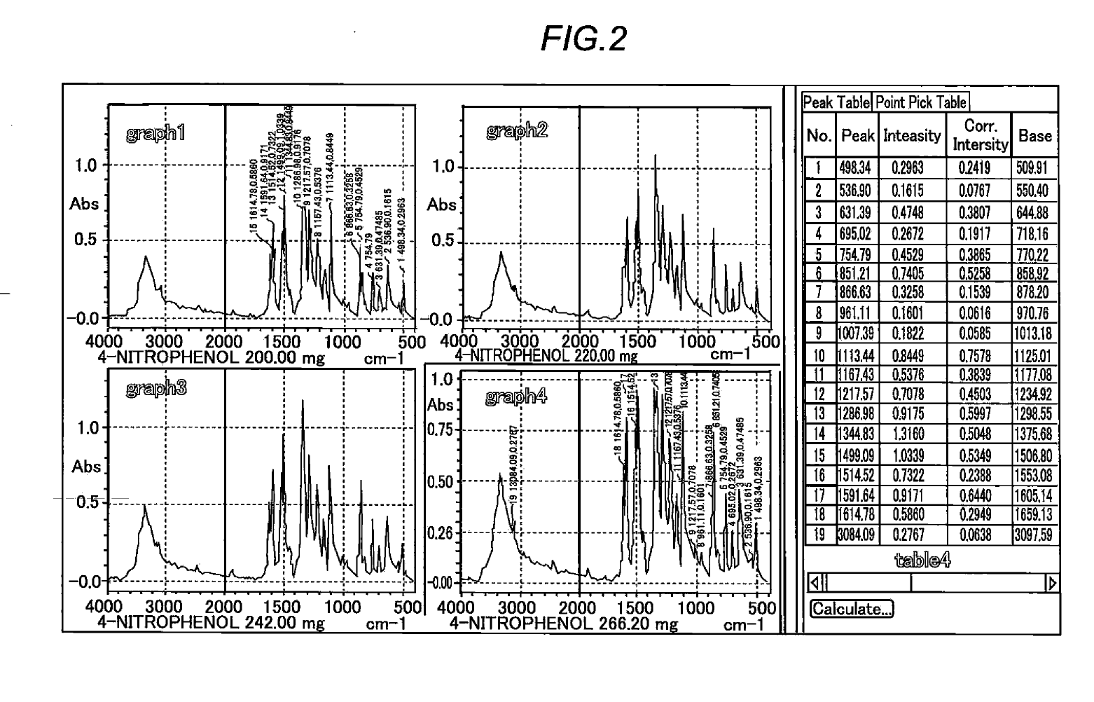

The screen image creation unit 23 displays, on the same screen, four absorption spectrum (Graphs 1 through 4) and one table (Table 4) that were created by the graph/table creation unit and also defines such things as their size, aspect ratio and the display style (the scale to be used for the graph's axes, whether or not to display the intensity of the peak values). The graphs and tables that were set in this manner are placed as report objects on the monitor 50 as shown in FIG. 2 to create a screen image Im1. The screen image Im1 that is created can be stored in memory unit 40.

The operation of the automatic report creation unit 24 of the present embodiment is described next.

The present embodiment of an automatic report creation program includes functions for: (1) automatically creating a template file that holds the screen image that is stored in memory unit 40; (2) creating a report using the report template that was automatically created; and (3) outputting the report that was created to a printer and printing the report. These functions are described in detail below.

### (1) Template File Creation

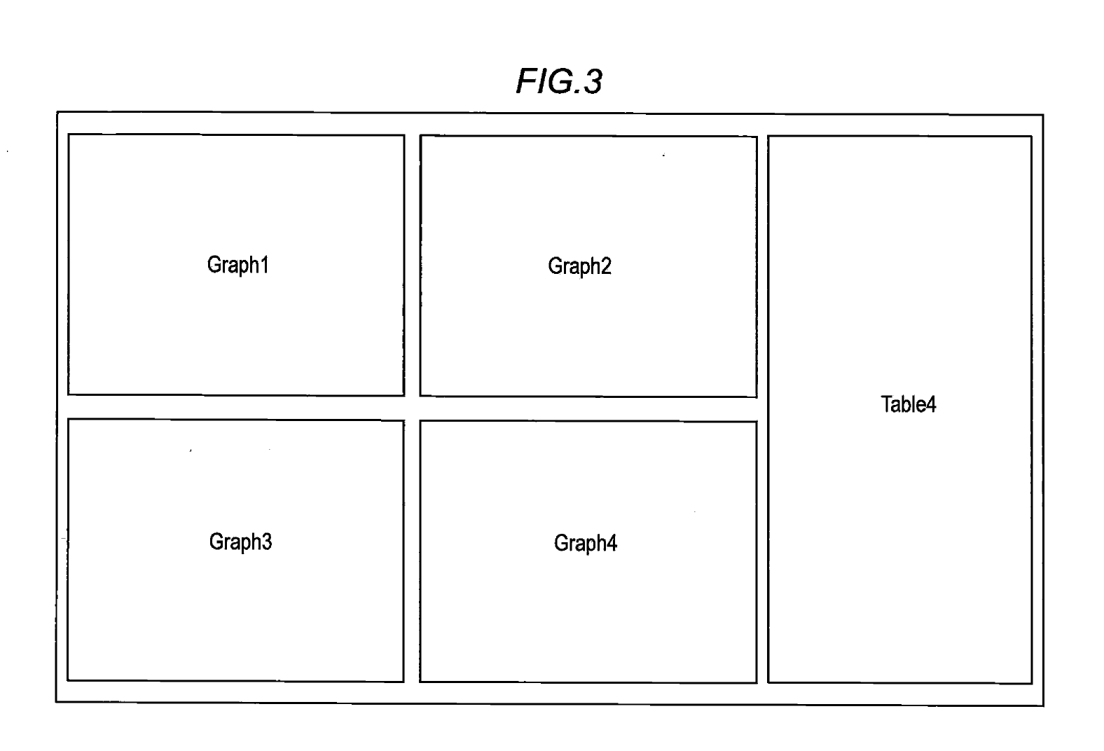

The template creation unit 241 uses the screen image Im1 (FIG. 2) that is stored in the memory unit 40 and the size of the report form defined in advance by the user to calculate the vertical and horizontal size of the respective objects and the layout positions of the objects so that the screen image Im1 is maintained. The template creation unit 241 uses the calculated information to automatically create a report template T1 (see FIG. 3) that defines the layout positions and the vertical and horizontal sizes of the respective objects in the report. The report template T1 that is created is stored in the memory unit 40.

### (2) Report Creation

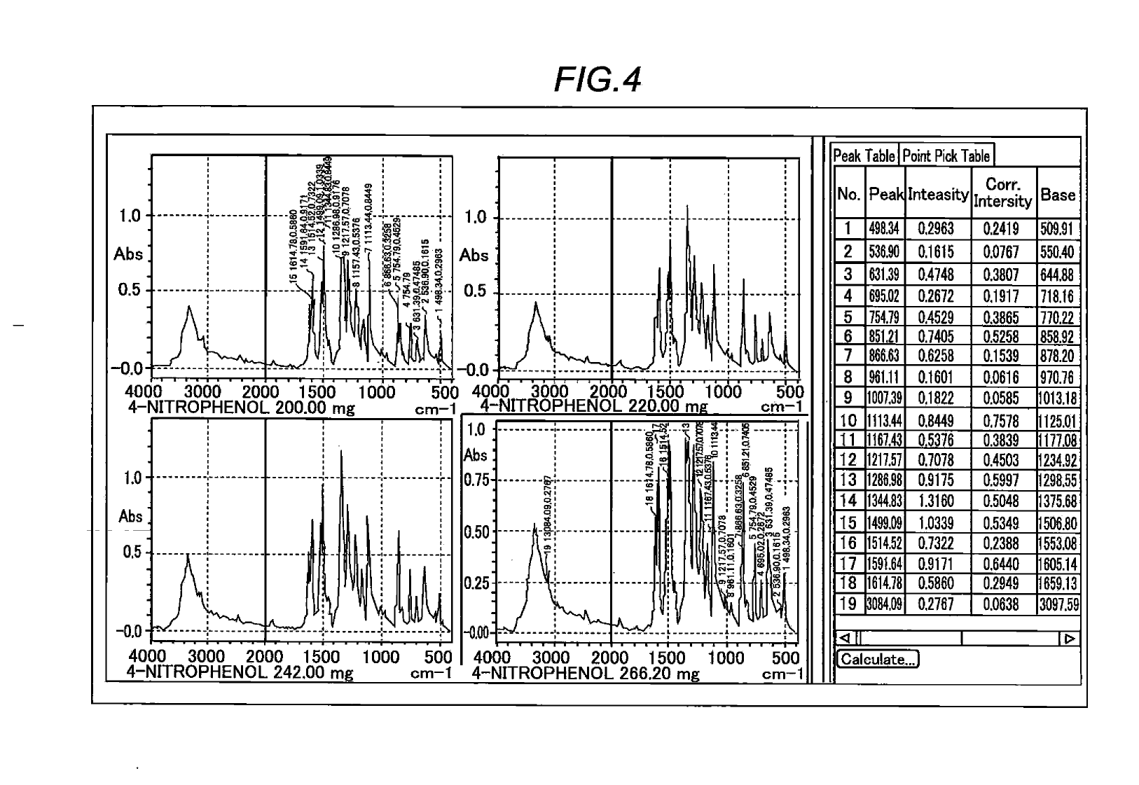

The report creation unit 242 reads the report template T1 that is stored in the memory unit 40. Next, based on the user instructions that are entered from the input unit, the report creation unit 242 reads from the memory unit 40 the measurement data M1 through M4 for the objects to be displayed in the report and supplies the measurement data that is read to the report template T1, causing the automatic creation of a report (see FIG. 4) based on the report template T1 (FIG. 3).

### (3) Report Output

The report that is created by the report creation unit 242 is output by the report output unit 243 to the printer 60 where the report is printed on a report form (see FIG. 4).

When the report that is output (FIG. 4) and the screen image shown in FIG. 2 are compared, it is evident that the screen image such as the general layout and the display style of the spectrum (Graphs 1 through 4) and the table (Table 4) is preserved. However, the aspect ratio and the size of the Graphs 1 through 4 and Table 1 have been changed to match the size of the report form.

According to the present embodiment of the analysis processing apparatus, the report creation unit 242 reads multiple measurement data sets which are sequentially provided to the report template. This simplifies the creation of a plurality of reports sharing the same template and greatly reduces the labor required by the user for the creation of reports.

Even though, with the afore-described embodiment, the report template T1 that was automatically created by the template creation unit 241 was used as is to create a report, a first variation of the afore-described embodiment is to provide a function (template editing function) to the report creation unit 242 that allows a user to suitably edit a report template and to store the edited report template. Examples of this may be to create a report after adding some new items or to edit some report objects. These things are performed by using the report creation unit 252 to read and edit the report template T1 that is stored in the memory unit 40.

This allows adding new display items to an existing report template or to create a new template by editing report objects in existing report templates.

A second example of a variation of the afore-described embodiment is to provide a function (report editing function) to the report creation unit 242 for editing the reports that were automatically created. This function can perform such things as changing the display style of individual objects or adding objects that are to be newly displayed in a report.

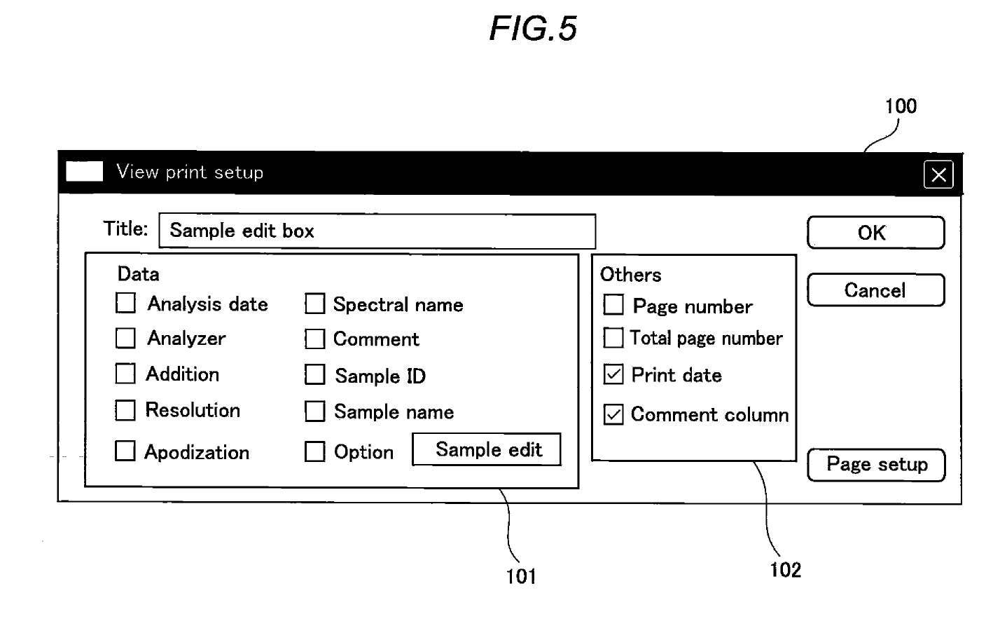

Specifically, the report creation unit 242 displays a display style change screen 100 such as that shown in FIG. 5 on monitor 50 and allows users to add objects that are to be displayed in a report. The display style change screen 100 includes a display style setting field 101 for data display and a display style setting field 102 for other display items. With this variation, the data display style setting field 101 allows the user to define such items as the date and time of the analysis, the identity of the person performing the analysis, the sample ID and the like. The display item setting field 102 allows the user to define such items as the page number, the total number of pages, the printing date and time, comments, and the like.

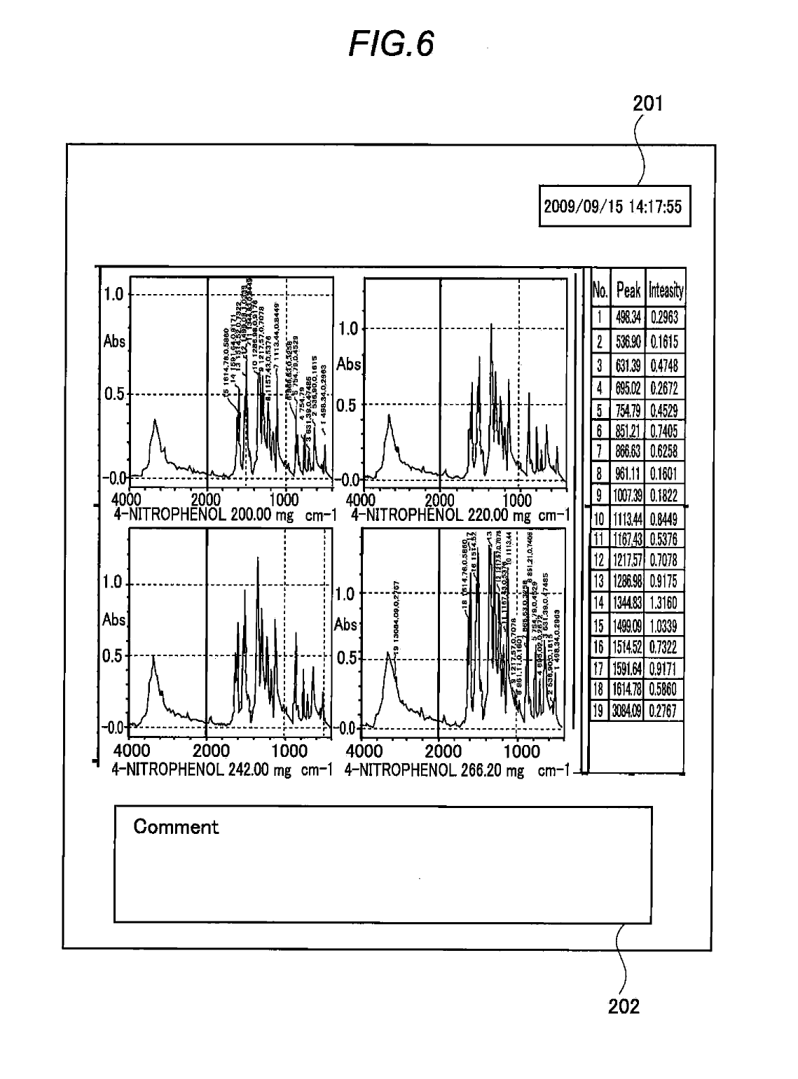

With the present variation, because the checkboxes for “print date and time” and “comment field” are checked by the user in the other display item setting field 102, the report (see FIG. 4) before editing is changed to the report as shown in FIG. 6. A comparison of FIG. 6 against FIG. 2 or FIG. 4 shows that the screen image such as the general layout and display style of the spectrum (Graphs 1 through 4) and the table (Table 4) is preserved but that the printing date and time item 201 and the comment field 202 have been newly added. Along with that, the size and aspect ratio of the respective report objects (Graphs 1 through 4 and Table 4) have been changed. The items that are included in Table 4 have also been changed.

Furthermore, with this variation, it is possible to create a report template T2 that corresponds to the edited report (FIG. 6) in accordance with instructions from the user.

In addition to the display style change screen 100 shown in FIG. 5, the report editing function is capable of displaying a graph attribute editing screen or a table attribute editing screen for editing the attributes of graphs and tables. The respective screens can be used for changing the scale for the graph axes of the graphs, the interval between the gradations on the axes, the items displayed in the tables and the like.

The present invention is not limited to the afore-described embodiments and variations, and various changes are possible without deviating from the scope of the gist of the present invention.

For example, even though a FTIR apparatus is used as the measurement apparatus in the present embodiment, the present invention is not limited to the use of a FTIR apparatus as the measurement apparatus, and various specimen measurement apparatuses can be used. Furthermore, it is possible for the screen image creation unit to display new items as report objects. Still furthermore, by selecting in advance the data that is to be covered by a report, the work from template creation to report output can be automated.

### DESCRIPTION OF THE NUMERICAL REFERENCES

10. FTIR measurement unit
20. Central control unit
21. Measurement control unit
22. Chart/table creation unit
23. Screen image creation unit
24. Automatic report creation unit
30. Input unit
40. Memory unit
50. Monitor
60. Printer
241. Template creation unit
242. Report creation unit
243. Report output unit

What is claimed is:

1. A data analysis processing apparatus for creating a report by supplying measurement data to a report template, said data analysis processing apparatus comprising:
a display screen;
a graph/table creation means for allowing a user to create graphs/tables based on measurement data;
a screen image creation means for displaying on said display screen one or more graphs/tables that were created by said graph/table creation means and allowing a user to define the form, size and layout of each of said graphs/tables that are displayed and thereby creating a screen image;
an output media setting means for defining the size and shape of the output media to which displayed objects on said display screen are output; and
an automatic report template file creation means for using the screen image that was created by said screen image creation means to create a report template file that fits the size and shape of the output media that is defined by said output media setting means.

2. A specimen measurement apparatus comprising:
a specimen measurement unit for measuring a specimen; and
a data analysis processor for creating a report by supplying measurement data obtained by said specimen measurement unit to a report template;
wherein said data analysis processor comprises:
a display screen,
a graph/table creation means for allowing a user to create graphs/tables based on measurement data;
a screen image creation means for displaying on said display screen one or more graphs/tables that were created by said graph/table creation means and allowing a user to define the form, size and layout of each of said graphs/tables that are displayed and thereby creating a screen image;
an output media setting means for defining the size and shape of the output media to which displayed objects on said display screen are output; and
an automatic report template file creation means for using the screen image that was created by said screen image creation means to create a report template file that fits the size and shape of the output media that is defined by said output media setting means.

3. A program for executing on a computer having a display screen; an output means for outputting displayed objects that are displayed on said display screen to an output media; and a function for creating a report by supplying measurement data to a report template, said program comprising:
a graph/table creation function for allowing a user to create graphs/tables based on measurement data;
a screen image creation function for displaying on said display screen one or more graphs/tables that are created by said graph/table creation function, allowing a user to define the form, size and layout of each of said graphs/tables that are displayed and thereby creating a screen image; and
an automatic report template file creation function for using the screen image that was created by said screen image creation function to create a report template file that fits the size and shape of said output media.
